(19) United States
(12) Patent Application Publication
(10) Pub. No.: US 2015/0205935 A1
(43) Pub. Date: Jul. 23, 2015

(54) PRESCRIBED RECOVERY CONTINUUM CARE PLAN COMPLIANCE APPARATUS AND METHOD OF USE

(71) Applicants: Kenneth R. Seeley, Palm Springs, CA (US); Eric J. McLaughlin, Palm Springs, CA (US)

(72) Inventors: Kenneth R. Seeley, Palm Springs, CA (US); Eric J. McLaughlin, Palm Springs, CA (US)

(21) Appl. No.: 14/158,590

(22) Filed: Jan. 17, 2014

(51) Int. Cl. G06F 19/00; G09B 5/00; G09B 19/00; G06Q 10/10; H04W 4/02

(52) U.S. Cl. CPC G06F 19/3475; G06Q 10/1095; H04W 4/025; G09B 19/00; G09B 5/00

(57) ABSTRACT

A compliance module configured to support the addiction recovery process. The compliance module includes a user interface downloadable to a mobile computing device that connects through the Internet to computer workstations using a standard web browser. The user interface provides participation statistics on what the users have and have not been doing that is prescribed from administrators and advocates in order to stay on track with the user's treatment plan and sobriety protocol. The system can be used to present evidence to those concerned, such as licensing boards, courts, employers, trust accounts, insurance carriers, loved ones with concerns, sponsors and, most immortally, users themselves. Relapse happens much too often when addicts do not stay accountable to the prescribed recommendations. This combination of a compliance module, mobile computing device and workstation will provide the user and health care advocates with real-time tools to stay on track.

### BACKGROUND OF THE INVENTION

The present invention relates to the field of health care, and more particularly to addictions recovery. The present invention provides an apparatus and method for addiction recovery compliance tracking.

Drug and alcohol abuse, as well as other addictions, is unfortunately a harsh reality that many families deal with. Online assessment tools are a known source for assisting patient compliance with addiction recovery; however, such self-guided programs are not a complete solution.

The patient may work with a specialist to provide compliance services. Working with a specialist is valuable not only to help break the cycle of addiction, but also for providing monitoring and testing protocols that create motivation for the patient to change, in some facilities, case managers work closely with the patient, the family, a treatment center and treatment providers so that everyone stays on track and with the same goals for the patient. Monitoring patient compliance with the protocols provided by the specialist increases the probability for continued sobriety. Currently, there are few tools fir the specialist to monitor and assist patient compliance.

Accordingly, there is a need for, and what was heretofore unavailable, an integrated system using a portable device configured with a compliance module and using administrator-advocate workstations that assists a recovering addict (patient) and her/his support community with the recovery process. The present invention satisfies these and other needs.

### SUMMARY OF THE INVENTION

Briefly, and in general terms, the present invention is directed to a patient compliance apparatus and method. The compliance system is configured so as to provide tools for the patient and one or more health care specialists (recovery advocates) to monitor compliance with the prescribed treatment plan and sobriety protocols. In one aspect, the present invention provides an apparatus and method of use for the patient to interactively monitor and document her/his compliance with the treatment process using a compliance module resident on a mobile computing device (commonly referred to as an “app”). In a further aspect, the present invention provides an apparatus and method of use for a health care specialist to assist the patient with adherence to treatment plans and sobriety protocols using a computer workstation configured with an Internet web browser. The compliance system can be used to present evidence to those concerned, such as licensing boards, courts, employers, trust accounts, insurance carriers, loved ones with concerns, sponsors and, most immortally, users themselves. The system will be very useful to people in early recovery wanting to monitor their progress in recovery. High licensed profession diversion programs (for example, for lawyers, doctors, nurses, pharmacists, and pilots) can benefit from the system of the present invention for measuring compliance to recovery.

The monitoring system of the present invention includes a user interface system that includes a computer hardware device having nontransitory machine-readable storage medium, for example, a smartphone mobile, cell phone) running customized software files and specialized programs in RAM, ROM and/or flash memory. The user interface includes a homepage, a contact list and an appointments calendar. The homepage subsystem is configured to add a sobriety date and a real-time counter. The homepage allows a user to add a saying to help patient motivation. The mobile user interface is further configured to add and maintain a contact list that an advocate for the patient (user) can contact in case of an emergency. The mobile user interface is further configured to enter and maintain the users' appointments. The calendar shows the user what is to be done for each day to support the recovery process. Notifications alert the user before calendared meetings, and the mobile user interface provides functionality for the user to verify attendance (‘check in’) at the appointment. An additional function of the mobile user interface is to provide the ability to request and receive (for example, from an administrator or advocate using a computer workstation) “Test Labs”, which are displayed as a local area list of places (with relevant contact information) the patient can obtain medical tests, drug screening or other tests relevant to the treatment program. As an added benefit, the mobile user interface compliance module provides a list of recovery support “Services”, for example, links to emergency and health care websites.

The present invention includes a dashboard (GUI) operable from a or other workstation. The workstation provides an administrator access to information uploaded (for example, to a server) from the user of the mobile user interface (compliance module). The administrator can create and manage client (user) information. In addition, the administrator may create, assign to clients and otherwise manage recovery advocates associated with the client/user. The present invention may be configured for advocates using a workstation to access certain client and other information available to the administrator. The administrator may also verify that the user of the compliance module has read and agreed to a HIPAA release form provided as part of the mobile user interface login procedure. The HIPAA release form provides permission from the user of the compliance module for the administrators and advocates to use the contact list and other information entered by the user in the event of an emergency of or user relapse from the prescribed treatment plan and sobriety protocols.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 is a schematic representation of one embodiment the hardware communication path of the present invention.

FIG. 2 is a schematic representation of one embodiment the hardware communication path of the present invention showing multiple user devices and multiple workstations.

FIG. 3A is a schematic representation of one embodiment of a mobile computing device in accordance with the present invention.

FIG. 3B is a schematic representation of one embodiment a computer workstation in accordance with the present invention.

FIG. 4 is a schematic representation of a screen display of a mobile computing device for user access to a compliance module in an embodiment of the present invention

FIG. 5 is a schematic representation of a screen display of a mobile computing device showing a home page for feature navigation in an embodiment of the present invention.

FIG. 6 is a schematic representation of a screen display of a mobile computing device for selection of user contacts in an embodiment of the present invention.

FIG. 7 is a schematic representation of a screen display of a mobile computing device for data entry of user contacts in an embodiment of the present invention.

FIG. 8 is a schematic representation depicting an embodiment of a calendar screen display of a mobile computing device in accordance with the present invention.

FIG. 9 is a schematic representation of a screen display of a mobile computing device for selection of calendared user appointments in an embodiment of the present invention.

FIG. 10 is a schematic representation of a screen display of a mobile computing device for data entry of user appointments in an embodiment of the present invention.

FIG. 11 is a schematic representation of a screen display of a mobile computing device for attendance verification of user appointments in an embodiment of the present invention.

FIG. 12 is a schematic representation of a screen display of a mobile computing device for selection of services available to a user in an embodiment of the present invention.

FIG. 13 is a schematic representation of a screen display of a mobile computing device depicting example testing site data provided to a user in an embodiment of the present invention.

FIG. 14 is a schematic representation of a ‘log in’ screen display of a workstation in accordance with the present invention.

FIG. 15 is a schematic representation of a ‘dashboard’ screen display of a workstation in accordance with the present invention.

FIG. 16 is a schematic representation of a client management screen display of a workstation in accordance with the present invention.

FIG. 17 is a schematic representation of a workstation screen display for creating a new client profile in accordance with the present invention.

FIG. 18 is a schematic representation of a recovery advocate management screen display of a workstation in accordance with the present invention.

FIG. 19 is a schematic representation of a workstation screen display for creating a new recovery advocate profile in accordance with the present invention.

FIG. 20 is a schematic representation of a workstation screen display for creating a database report in accordance with the present invention.

FIG. 21 is a block diagram of server functionality of one embodiment of the present invention.

FIG. 22 is a block diagram of the functionality of one embodiment a mobile computing device having a resident compliance module of the present invention.

FIG. 23 is a block diagram of the functionality of one embodiment of workstation functionality in accordance with the present invention.

FIG. 24 is a flow diagram for entering a ‘doctor’ contact into a mobile computing device in accordance with the present invention.

FIG. 25 is a flow diagram for entering and verifying appointment data from a mobile computing device in accordance with the present invention.

### DETAILED DESCRIPTION OF THE INVENTION

As shown in the drawings for purposes of illustration, the present invention includes a apparatus and method for providing one or more users (clients) and one or more health care advocates that assist the users of the system to monitor compliance with prescribed treatment plans and sobriety protocols.

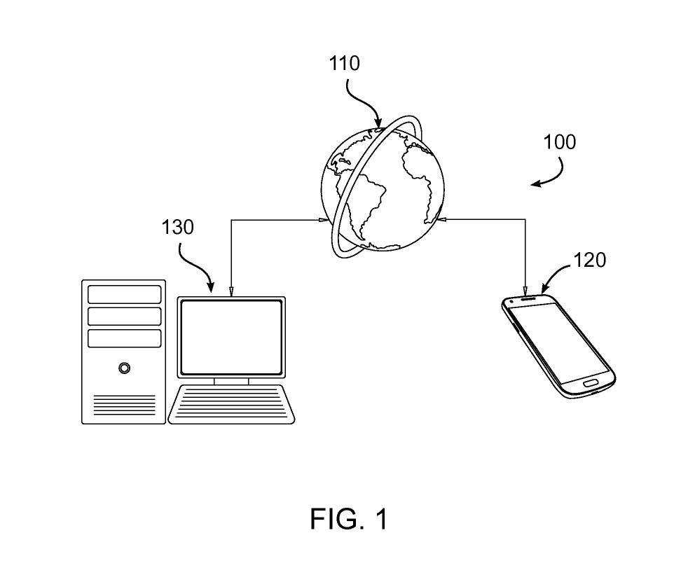

Turning now to the drawings, in which like reference numerals represent like or corresponding aspects of the drawings, and with particular reference to FIG. 1, the apparatus and process 100 of the present invention provide a user of a mobile computing device 120 configured with a user interface resident or stored in an apparatus having computer readable nontransitory storage medium (memory). The present invention further provides process for user data entry, for receiving data from remote computer workstations and for storing the user and third party data into the mobile computing device and its memory. The data is used by the user and advocates of the user for monitoring and assisting recovery treatment (plan) compliance.

The mobile user interface of the present invention includes functionality for transmitting data to and from administrators and advocates using a computer workstation 130, for example, via the Internet 110. By way of example, the mobile computing device may be a portable computing platform such as a cell (smart) phone, tablet computer, netbook, laptop computer or other suitable machines with nontransitory storage devices. The mobile computing device is configured to download and operate a compliance software application providing the mobile user interface and functionality for assisting with treatment plan compliance and sobriety protocols. Administrators and recovery advocates receive from and send data to the mobile user interface through an Internet (web) browser resident on the computer workstation configured with a dashboard (graphical user interface-GUI) for accessing data from, sending data to and accessing workstation functions.

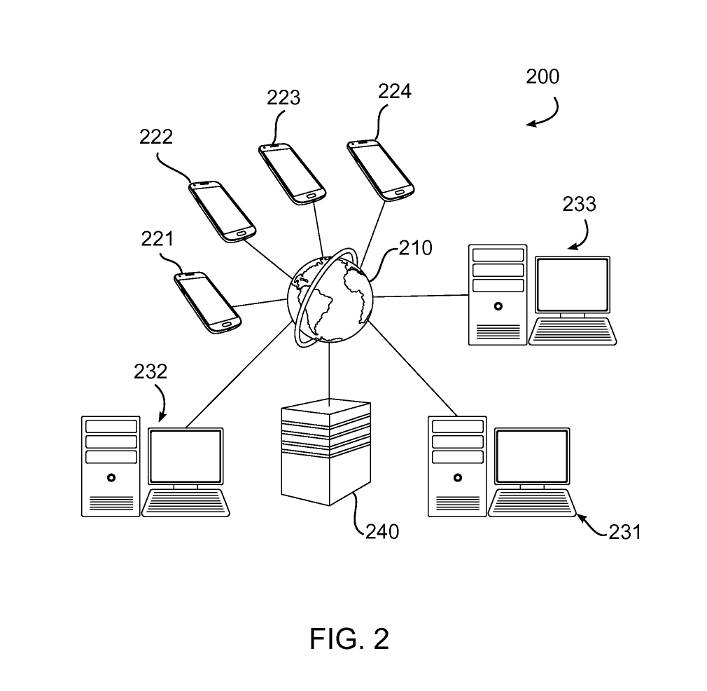

In an alternative embodiment of the recovery compliance assistance apparatus and process 200 is depicted in FIG. 2, wherein treatment data is entered into, stored at, an transferred from/to multiple mobile computing devices 221, 222, 223, 224. This embodiment of the present invention includes a computer server 240 (machine with nontransitory memory) that communicates to the user devices through the Internet 210. Similarly, data is transferred from (and to) multiple administrator and advocate workstations (for example, special purpose computers) 231, 232, 233 to (and from) the computer server through hardware and software resident in each workstation providing an Internet connection. Accordingly, the users of the portable devices communicate with the advocates (administrator) using the workstations over (through) the Internet, wherein the server computer is configured for receiving, storing and transmitting data as an interface between each mobile computing device and each workstations.

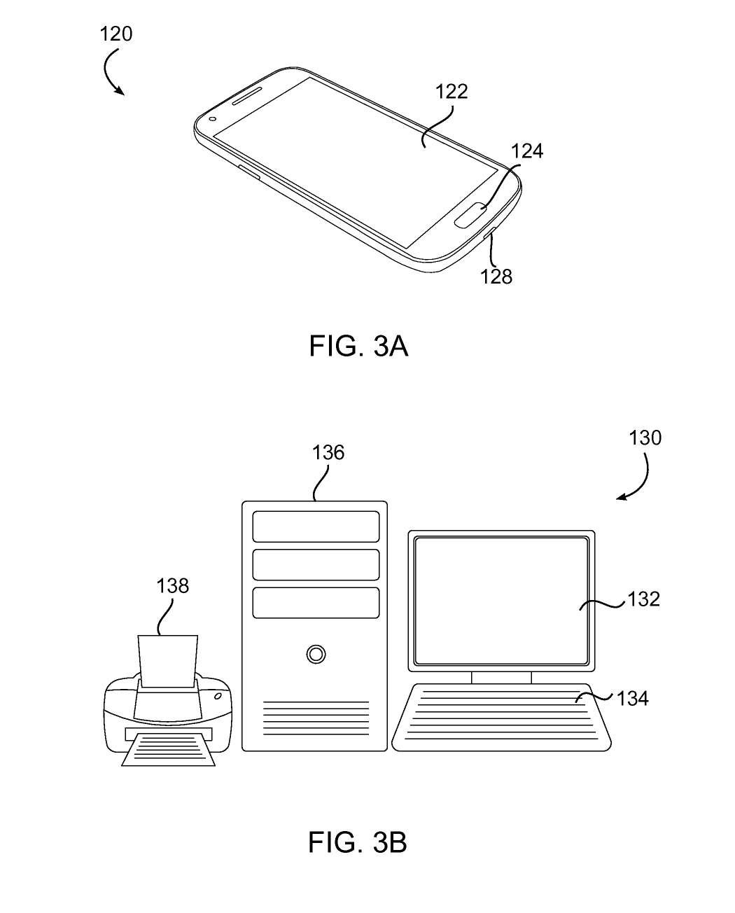

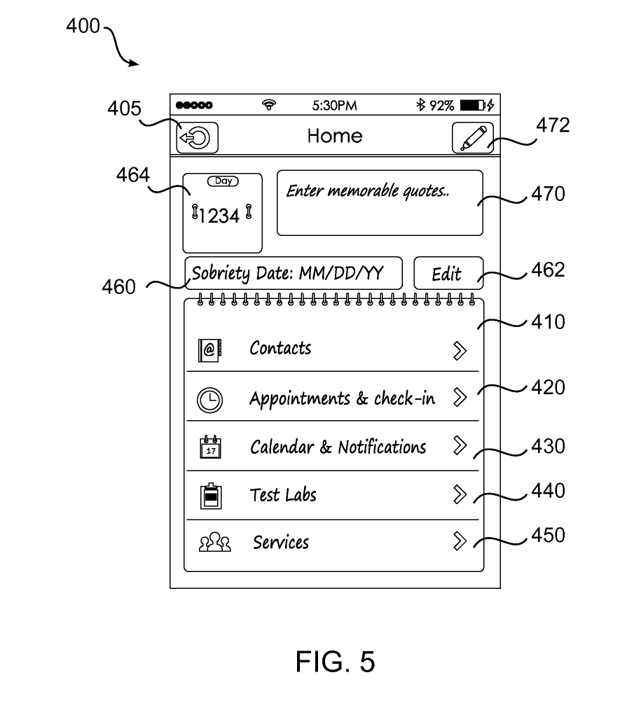

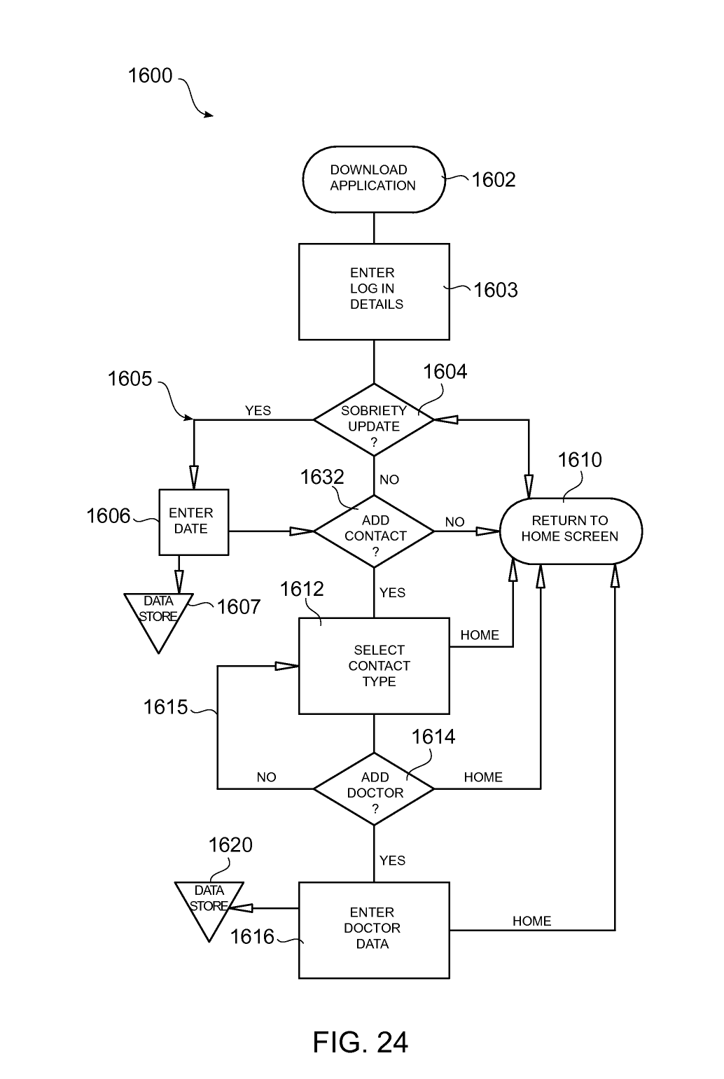

Referring now to FIG. 3A, one example embodiment of a mobile computing device 120 is a mobile (cell) phone or so-called “smart phone” having nontransitory memory for storing client input data, for example, a sobriety date (see FIGS. 5 and 24). As would be apparent to those one of ordinary skill in the art, suitable devices may be obtained from, but not limited to, (i) Apple, Inc. (Cupertino, Calif.) under the brand name “iPhone”, which uses the “iOS” operating system; (ii) Samsung Electronics Co., Ltd. (Seoul, South Korea), under the brand name “Galaxy”, which uses the “Android” operating system; and (iii) manufacturers that use Microsoft Corporation's (Redmond, Wash.) “Windows Mobile” operating system. The mobile computing device is configured to download, host and execute application modules for various functionality consistent with the viewing screen 122 of the device. The mobile computing device may include a separate keyboard (not shown) for entering user data or may be configured with ‘touch screen’ hardware and associated software for data input and navigation of the application module's functionality.

The display screen 122 of the mobile computing device 120 may be touch sensitive, including gesture functionality. The display screen can be structured from, for example, a glass, a plastic, a thin-film or a composite material. The touch sensitive screen may be a transflective liquid crystal display (LCD) screen. The display screen aspect ratios and resolution may be different without departing from the principles of the present invention. By way of example, embodiments of the display screen may be formed from an active matrix liquid crystal display (AMLCD), a thin-film transistor liquid crystal display (ITT-LCD), an organic light emitting diode (OLED), an interferometric modulator display (IMOD), a liquid crystal display (LCD), or other suitable display device. In an embodiment, the display provides color images. In another embodiment, the mobile computing device is configured with a touch-sensitive display, for example, incorporating pressure-sensitive (resistive), electrically sensitive (capacitive), acoustically sensitive (SAW or surface acoustic wave) and/or photo-sensitive (infra-red) technology. The display screen may include a digitizer for receiving input data, commands or information from a user of the mobile computing device. The user may use a stylus, a finger or another suitable input device for data entry, such as selecting from a menu or entering text data.

The mobile computing device 120 may also include a speaker, a microphone and one or more switches, buttons, sliders, or rocker switches and can be mechanical or solid state, such as a power button 124. In addition, the mobile computing device may include one or more ports 128 for connecting to an external device, such as a computer workstation, external memory or other hardware as is or will be known to one of ordinary skill in the art of computer and/or mobile phone technology.

It is noted that for ease of understanding the principles disclosed herein are in an example context of a mobile computing device 120 with telephonic and other wireless functionality operating in a mobile telecommunications network. However, the principles disclosed herein may be applied in other devices with functionality configured to interface with present and future data networks having functionality for transmitting and receiving data packages, such as application modules. Likewise, the mobile computing device disclosed herein is only by way of example, and the principles of its functionality apply to other computing devices now know and later developed.

As shown in FIG. 3B, the computer workstation 130 is well known to those of ordinary skill in the art of computer hardware and software systems. Such workstation typically include a display screen 132, a keyboard 134 and computing hardware, such as a tower 136 congaing microprocessors, nontransient, flash and other forms of memory. The workstation contemplated by the present invention includes a printer 138 or other hardware suitable for generating paper reports containing data related to the users (patients), administrators and advocates. As is known to one of ordinary skill in the art, the computing hardware may be integrated with the display screen and keyboard, such as in a laptop or a tablet computer.

It is noted that for ease of understanding the principles disclosed herein are in an example context of a computer workstation 130 configured with Internet functionality. However, the principles disclosed herein may be applied in other devices with functionality configured to interface with present and future data networks having functionality for transmitting and receiving data packages through so-called ‘web browsers’, such as Microsoft's “Internet Explorer”, Google's “Chrome” and Apple's “Safari”. Likewise, the computer workstation disclosed herein is only by way of example, and the principles of its functionality apply to other computing devices now know and later developed.

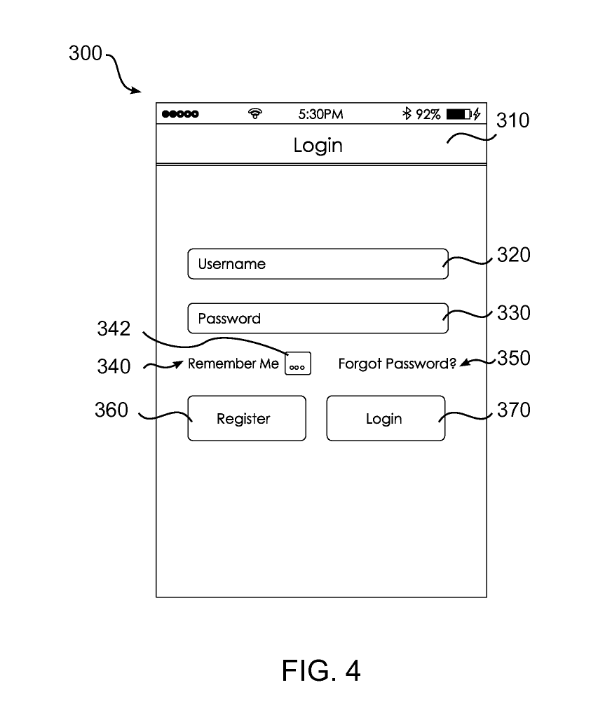

Referring now to FIGS. 4-13, the mobile user interface of the application module of the present invention is configured for customizing and personalizing the functionality of the apparatus and process for assisting in the compliance of a users' treatment plan and sobriety protocols. As discussed further herein, the functionality of the application module is with respect to the embodiment of the present invention having a server computer 240 as shown in FIG. 2. Alternatively, many of the storage and other functions of the apparatus and method of the present invention may be provided by a user workstation without the need for an intermediate computer server, as shown in FIG. 1.

Turning now to FIG. 4, after download of the application module (see FIG. 24) the user is provided with a screen 300 specifically identified for “Login” 310. The user is provided fields for entering a “Username” 320 and a “Password” 330. First time users ‘push’ (touch, swipe, click) the “Register” button 360 (herein the term “button” refers to a potion of the mobile user interface that provides interaction with the user). Returning users push in the “Login” button 370. As is well known users of mobile user interfaces, first time users populate required data such as name, physical address, email address and phone number on one or more subsequent screens provided by the mobile user interface potion of the application module. The data entered by the user is transmitted and stored in the mobile computing device (nontransitory memory), wherein some data may be stored in the nontransitory memory of the computer server and/or in one or more administrator-advocate workstations. For example, the user may request that the application module store the username and password by pushing a “Remember Me” button. 340 having a confirmation indicator 342. In the case of the user wishing to retrieve or reset a password, a “Forgot Password” button 350 is provided so that an administrator or an automated server function can send a new password to the user's email address or execute a similar password reset procedure.

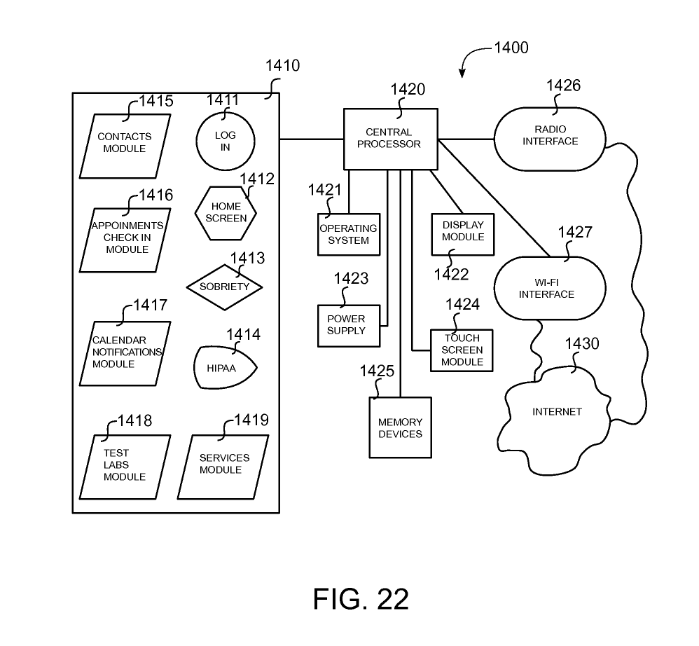

One embodiment of the “Home” page 400 provided in the mobile user interface configured into the mobile platform of the present invention provides interaction with administrator-advocate workstations for data maintenance, functionality program execution and for compliance data reporting is shown in FIG. 5. The “Home” page has a ‘close application’ (off) button 405 for terminating execution of the user interface by a central processing unit (CPU) of the mobile computing device (see FIG. 22). A portion 470 of the screen display is provided for the user to enter a personal, perhaps motivational, message for storage in the mobile computing device memory. An ‘edit’ button 472 on the home screen initiates compliance module functionality for the user to change and store the personal message. The message is retrieved and displayed each time the user directs the compliance module to revert to the mobile user interface “Home” page. The “Home” screen may be further configured with a field 460 for displaying a ‘Sobriety Date’ and a button 462 that initiates a screen for the user to enter the date. In addition, the “Home” page may display a running counter 464 of the elapsed days from the entered ‘Sobriety Date’.

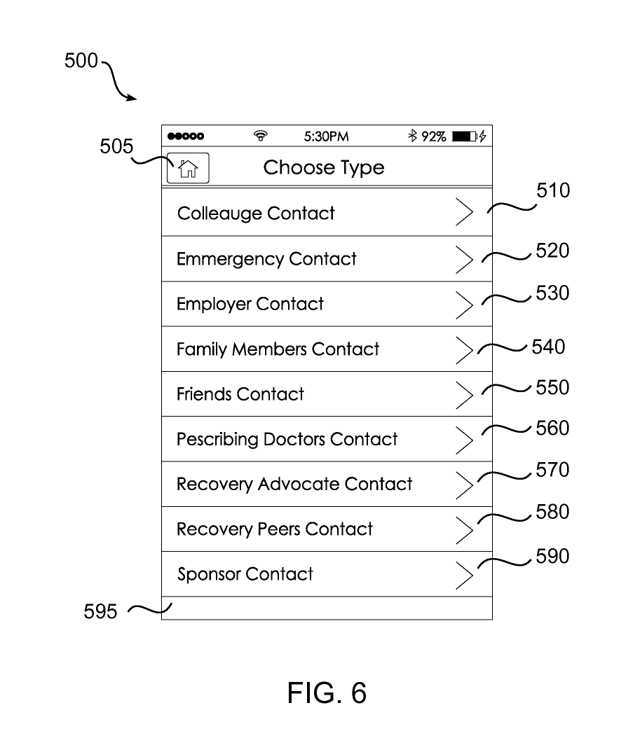

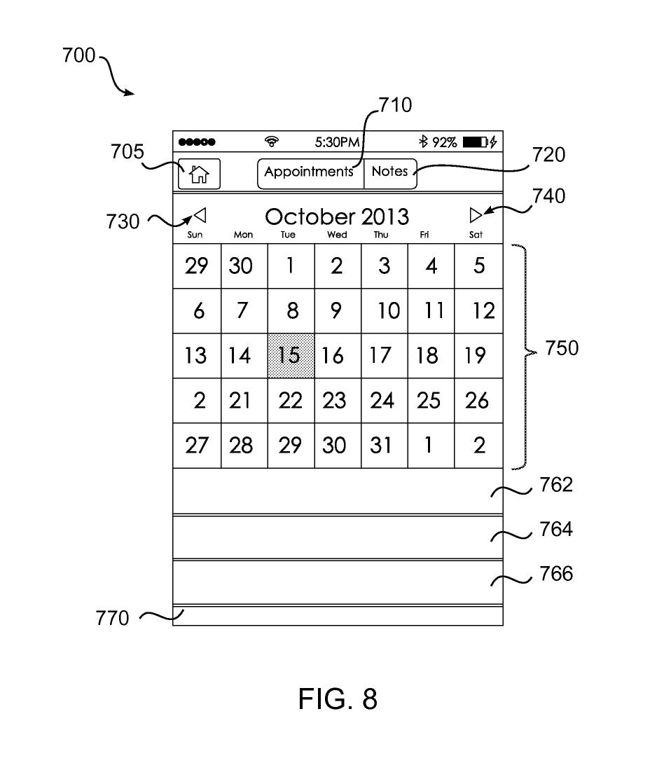

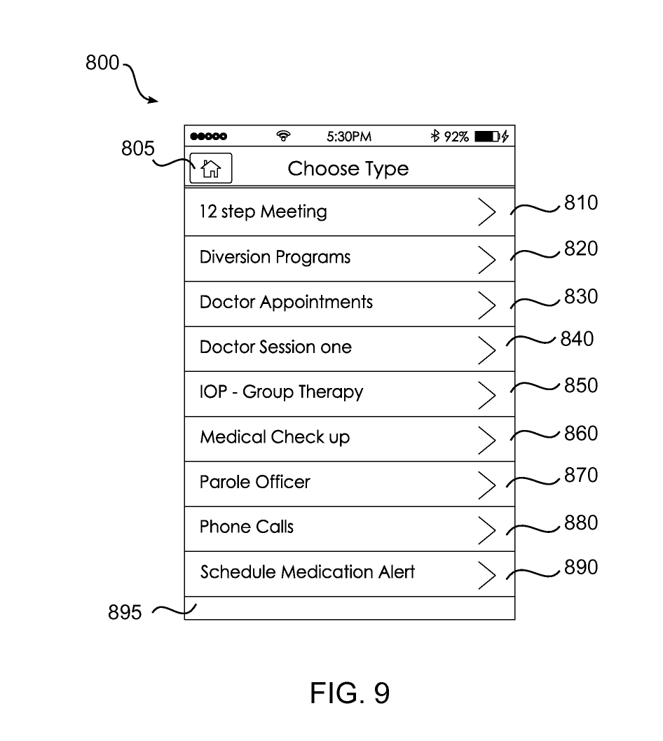

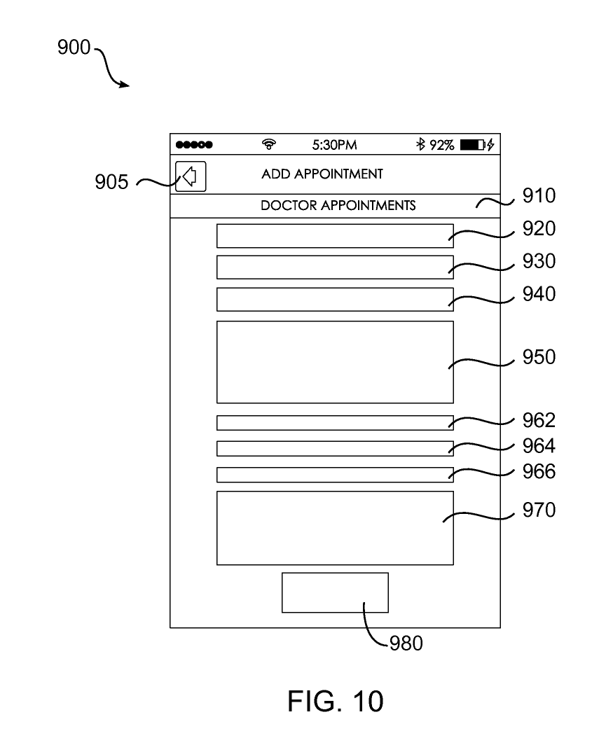

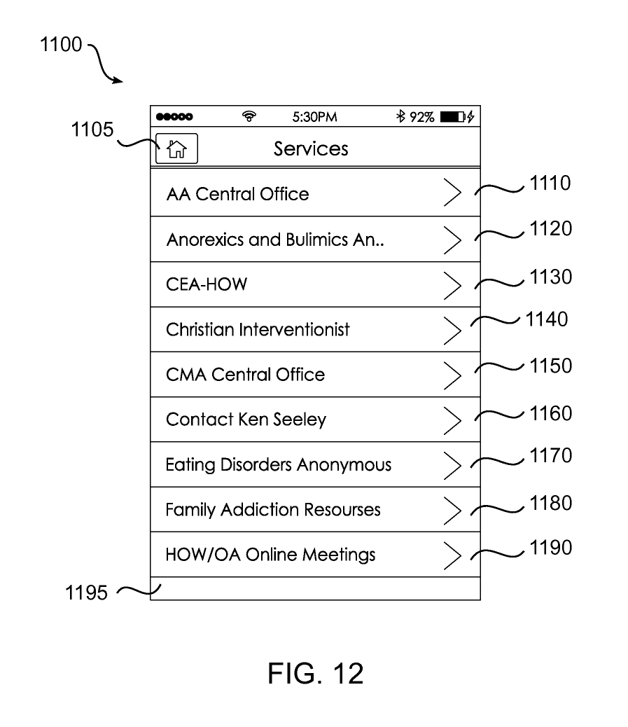

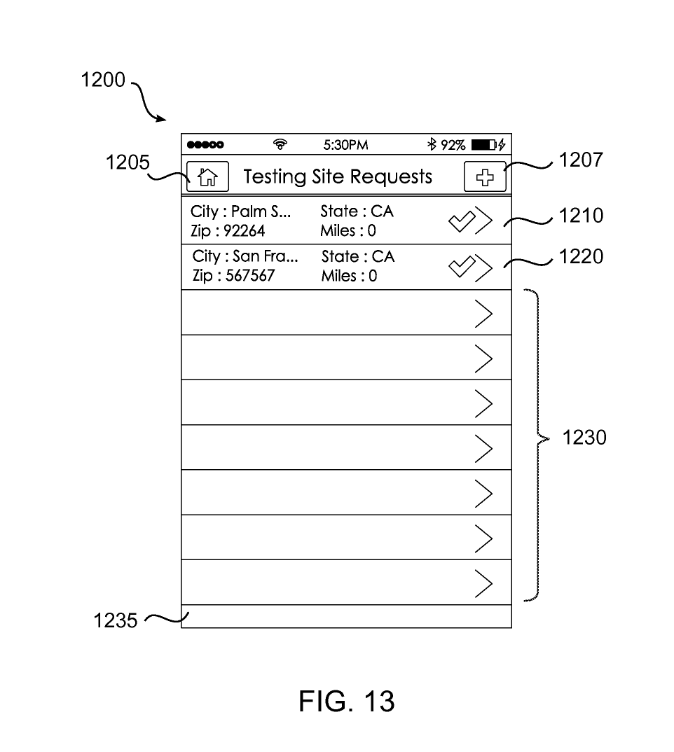

Further referring to FIG. 5, the “Home” screen 400 provides a menu of configurable functionality for the mobile computing device. By way of example, and not meant to be limiting, the compliance module includes dedicated portions of the mobile user interface (device screen) for execution of sub-modules for entry, storage and editing of contact information 410 (see FIGS. 6 & 7) and appointments 420 (see FIGS. 9, 10 & 1). Home screen functionality further includes a day calendar 430 (see FIG. 8), and access to data pertaining to available test labs 440 and to other services 450 available to the compliance module for presentation to the user (see FIGS. 12 and 13).

As shown in FIG. 6, the compliance module of the present invention provides functionality for a contacts list, including a contacts navigation page 500 that allows the user of the mobile user interface to select (“Chose Type”) from preset categories 510, 520, 530, 540, 550, 560, 570, 580, 590 of contacts. The contacts list presented herein is by way of example only, and is not considered to be exhaustive or to be limiting. Pressing the ‘home’ button 505 returns the user display to the compliance module home page (FIG. 5). Pressing one of the category buttons (“>”) retrieves a list of entries populated by the user for that contact type. The contacts list screen may also be configured with scrolling functionality 595, such as up and down by finger swipes, as provided by the particular platform operating the mobile user interface of the compliance module.

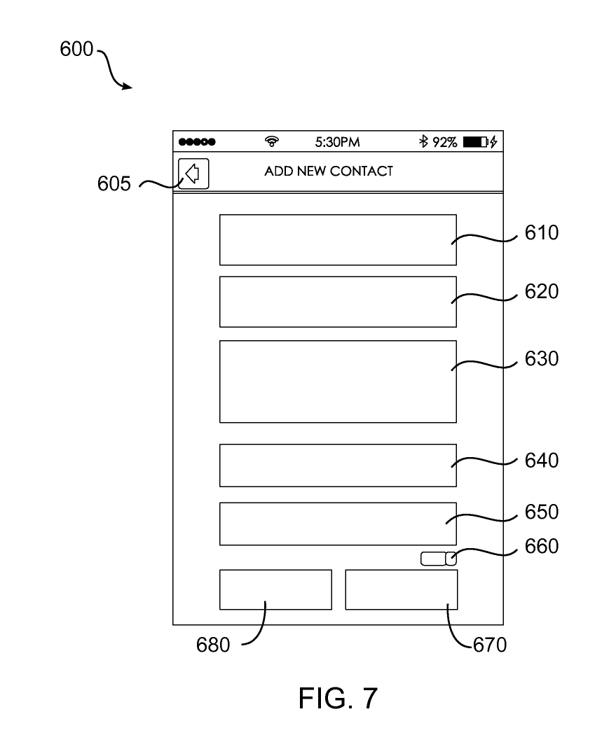

Data entry for a contact is performed through the mobile user interface by using a “ADD NEW CONTACT” page 600, as illustrated, by way of example, in FIG. 7. The contact data entry page has fields configured for entry of the contact's first name 610, last name 620, physical address (Mailing, street, home, work) 630, phone number 640 and email address 650. Some Contact Type data entry screens, such as for “Prescribing Doctors” 560, provide additional data entry fields customized for that contact type, for example, for entering prescribed medications. The user can elect to share this data with (transmit to) administrators and recovery advocate workstations by sliding the “Allowed to communicate” button 660 to “ON”. In the “OFF” setting, the data entry for the contact is only stored in the mobile computing device, for example, resident on flash, RAM or other memory components in the device hardware. The new contact data is stored by pressing the “Add” button 680 or is deleted by pressing the “Cancel” button 670. Pressing the ‘home’ button 605 returns the user display to the compliance module home page.

Referring now to FIG. 8, a calendar page 700 is accessible from the “Home” screen (page) of the mobile user interface (FIG. 5). Pressing the ‘home’ button 705 returns the user display to the compliance module “Home” page. Pressing the left arrow button 730 changes the displayed month backwards in time for each push of the left arrow button. Likewise, pressing the right arrow button. 740 changes the display to the next month for each push of the button. The current day is highlighted in the date (number) field 750 (as shown, “15”). By default, the “Appointments” page 710 displays appointments for the current date entered into the compliance module and stored on the mobile computing device (see FIGS. 9-11). Pressing a different day in the date field causes the compliance module to display any appointments entered by the user for that selected date. A summary of the details for each appointment for a selected day are displayed in the fields 762, 764, 766 below the date field. The list of appointments for the selected date may be scrolled up and down at the bottom 770 of the calendar page as provided by the particular mobile computing device.

Also referring to FIG. 8, reminders and other comments may be added into the compliance module by pressing the “Notes” button 720 on the Calendar display page 700. When the “Notes” button is pushed on the Calendar display page, a list of entered reminders-comments is displayed, for example, in alphabetical order by title of the note or in chronological order as entered by the user. The “Notes” display page is configured with appropriate functionality and data fields for adding and editing a title and the substantive text for each reminder-comment.

As shown in FIG. 9, when the “Appointments & Notifications” button 420 is activated from the “Home” display page 400 (FIG. 5), a list of appointment types is displayed so that the user may select a particular appointment type configured into the compliance module of the mobile computing device. When the user chooses the “Appointments & Notifications” tab, a listing display (“Choose Type”) 800 allows the user to select from a list of appointment categories 810, 820, 830, 840, 850, 860, 870, 880, 890 for further display and functionality. For example, selecting the “Schedule Medication Alert” tab 890 initiates further screens for the user to set a schedule, which may be recurring daily, for taking a particular medication. The compliance module may display ‘banners’, ‘alerts’ or other notifications to the user on the mobile computing device when the scheduled medication appointment time arrives. Additional appointment and notification types may be listed and available by scrolling from the bottom portion 895 of the mobile computing device display screen. Pressing the ‘home’ button 805 returns the user display to the compliance module home page.

Referring now to FIG. 10, the compliance module of the present invention includes functionality and a data entry screen 900 for the user (patient) to enter the relevant data of a particular appointment. For example, the user may request that the compliance module “Add APPOINTMENT”, wherein the type of appointment chosen is shown in a field 910 near the top of the display. In FIG. 10, the data entry fields 920-970 for a “DOCTOR APPOINTMENT” are shown for entering the required data. As with most data entry fields configured in the compliance module of the present invention, the files are populated with text indicators for the field type. On the “DOCTOR APPOINTMENT” screen, the relevant fields are for appointment type 920, the doctor's name 930, phone number 940 and address 950. The compliance module may be configured to provide an operable data entry user interface (data fields) and functionality for scheduling medication alerts.

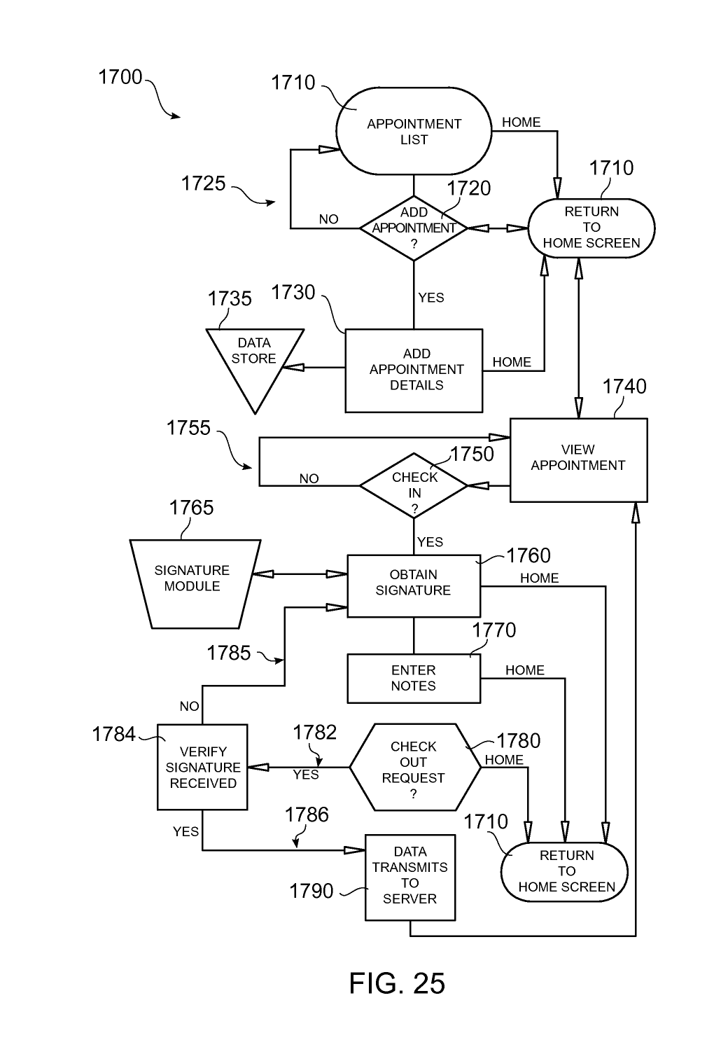

Additional data entry fields for a doctor appointment page 900 may include appointment date 962, starting time 964 and ending time 966. A further free form text field may be provided for entering an specialist description 970. The mobile user interface provides an “ADD” button 980 for saving the appointment and integrating the appointment with the calendar and other functionality of the compliance module. The user can return to the “Choose Type” of appointment display page 800 by bushing a back arrow 905 located, for example, at the top of the mobile computing device display screen. The user data is then added to the calendared appointments in the mobile computing device memory for use by the compliance module, for example, for displaying to and editing by the user in the calendaring and appointment verification functionality (see FIG. 25). Depending on the mobile user interface platform, the reminders may appears as ‘notifications’ and/or ‘banners’, on the mobile computing device display screen.

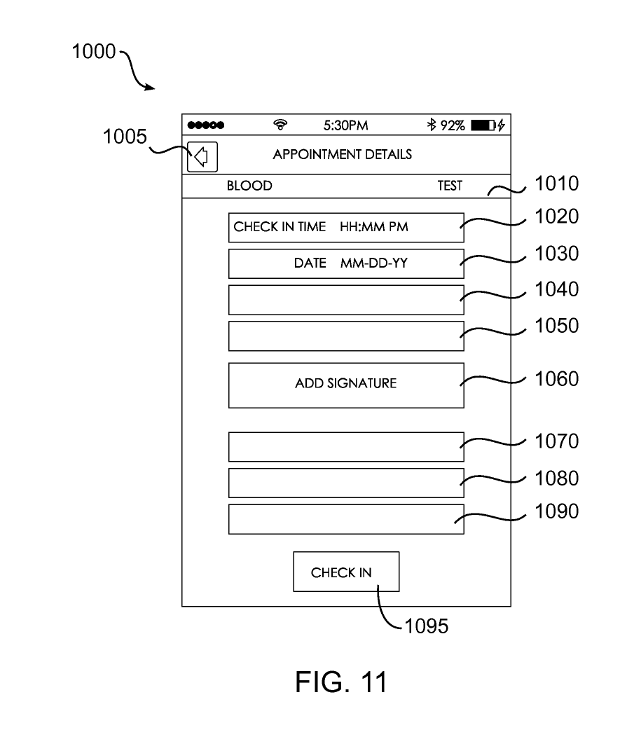

As shown in FIG. 11, an appointment verification page 1000 is used to allow the user to ‘verify’ or ‘check in’ to an appointment (see also FIG. 25). The verification page is configured with a ‘back’ button 1005 that reverts the mobile user interface to the appointment selected from the “Choose Type” selection page 800 (FIG. 9) or from the Calendar page 700 (FIG. 8) where the appointment was listed for the user by the compliance module from the appointment information data stored in the mobile computing device memory. A description field 1010 is populated with the description of the appointment type entered by the user when the appointment was scheduled (FIGS. 10 and 25). The ‘CHECK IN TIME” field 1020 and the “DATE” field 1030 are automatically populated by the compliance module of the present invention when the user elects to check in (verify attendance) at the appointment. The name (display field 1040), the phone number (display field 1050), the address (display field 1070) of the contact person to verify the attendance and the description (display field 1080) of the appointment may be populated by the compliance module into the user screen fields from the previously entered data for each appointment. Alternatively, the user may manually enter the contact information data fields when populating the appointment data. The mobile user interface displays fields for the ‘check in’ page 1000 may vary depending on the appointment type (FIG. 9). In addition, the user may populate a ‘notes’ field 1090 regarding her/his attendance at the scheduled appointment.

With further reference to FIG. 11, the “APPOINTMENT DETAILS” page 1000 provides functionality for verification of the user (patient) at the scheduled appointment. Those of ordinary skill in the art could implement, without undue experimentation, a GPS, Wi-Fi or other suitable location device (for example, those currently used in smartphones) and a process to verify attendance of the user at the previously specified time and place for the scheduled appointment (a location stamp). The location stamp may be transmitted to an advocate workstation for comparison of the known location of the scheduled appointment and the actual location when the user verifies attendance. Alternatively or in conjunction with the location stamp, a separate verification access button 1060 may be operably connected to a verification module 1765 (FIG. 25). For example, the “ADD SIGNATURE” button on the “APPOINTMENT DETAILS” page may be configured to activate a separate signature screen (not shown) that may be similar to screens used for authorizing a purchase at a doctor's office, pharmacy, or other vendor terminal, as is known in the art. Accordingly, the user may hand the mobile computing device to the physician, counselor or other authorized person to sign the signature display field, which may include buttons to cancel (clear) or verify the signature. Verification of the appointment (including the signature and/or location stamp) may be stored on the mobile computing device, the computer server and at the administrator-advocate workstation. Verification of the appointment (for example, by signature, location stamp) may be a requirement of the compliance module to complete the ‘check in’ process when the “CHECK IN” button 1095 is pushed by the user (see FIG. 25).

Referring now to FIG. 12, the mobile user interface may include a listing 1100 of available “Services” populated when the compliance module was configured and when updates to the compliance are downloaded. Each button (field) 1110-1190 provides a link (“>”) to further pages in the compliance module with relevant data for each service. For Example, “Contact Ken Seeley” may be populated with Mr. Seeley's particulars, such as, but not limited to, contact phone number, email address, website URL and relevant notes about the services he provides. The data fields may vary for a particular service type to accommodate all relevant information. The “Services” screen of the mobile user interface is also configured with scrolling functionality 1195 as is provided by the particular platform operating the mobile user interface of the compliance module. Pressing the ‘home’ button 1105 returns the user display to the compliance module home page.

The “Test Labs” 440 button on the “Home” screen 400 (FIG. 5) allows the user to request available information regarding any testing site within a city, state, zip code, and/or distance based on user input data and/or a current location provided by the mobile computing device GPS or similar functionality. As shown in FIG. 13, a “Testing Site Request” screen 1200 is configured into the compliance module to provide the user functionality to request data 1207 to be populated into the testing site fields 1220, 1220, 1230. When the requested test site data is provided by an administrator (or advocate) from a workstation or ‘automatically” by a computer server (for example, using a ‘look-up-table’) the appropriate testing site request field may include a color-coded notification (for example, a green check-mark) that the data has been uploaded into the memory of the mobile computing device. Accordingly, the mobile user interface is configured to display the testing site details on a further page (not shown with relevant particulars, such as, but not limited to, site name, type, phone number and address. If no testing site is available within the parameters specified by the user (for example, miles within a designated location), the mobile user interface may display a color-coded notification, for example, a red letter “X”. Pressing the ‘home’ button 1205 returns the user display to the compliance module home page and scrolling functionality 1235 may be provided.

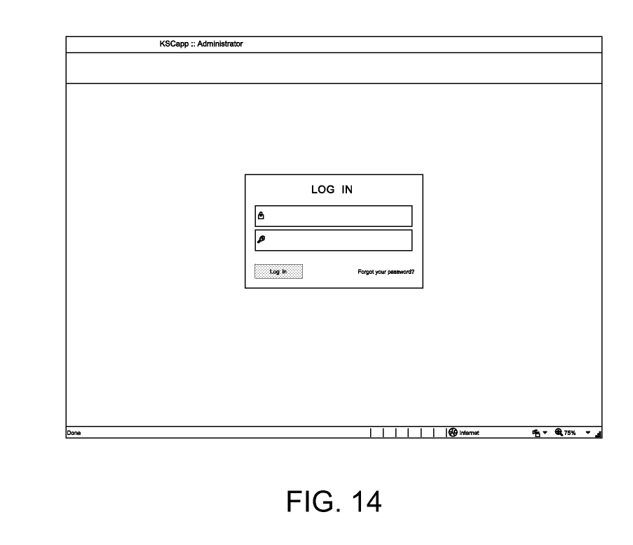

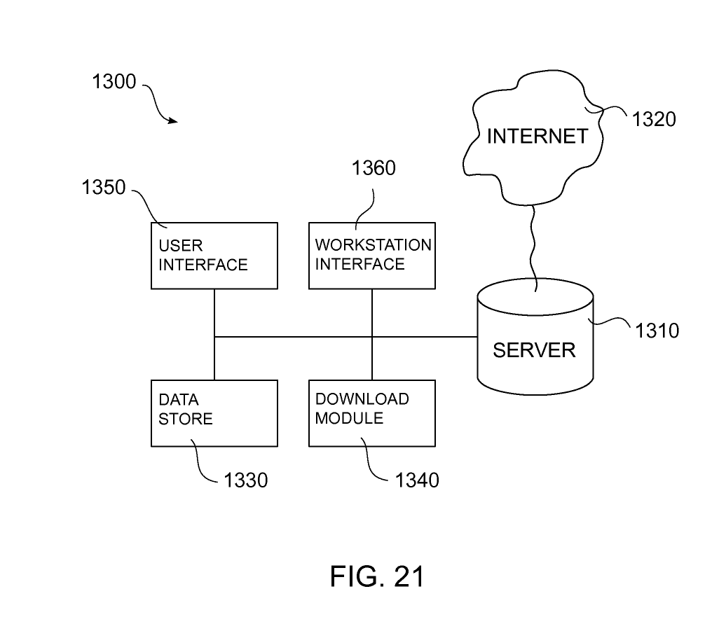

Referring now to FIGS. 14-20, the compliance system of the present invention includes functionality (website) for interfacing with a Internet (web) browser resident on a computer workstation. The workstation may be what is commonly called a personal computer (PC), an Apple, Inc. desktop computer, a laptop or tablet computer, so long as the workstation is configured with a now known or to be developed Internet interface software program (browser), such as Microsoft Inc.'s “Internet Explorer’, Apple Inc.'s “Safari” and/or Google, Inc.'s “Chrome”. By way of example, the administrator or other authorized user ((or example, a recovery advocate) ‘launches’ the web browser at a workstation and directs the browser to a specific website URL (Uniform Resource Locator, previously Universal Resource Locator), for example, http://www.compliancemodule.com/login (FIG. 14). The functionality for the website may be resident on a server, as shown in FIGS. 2 and 21. For purposes of the present example, the depictions of screen display are described for an administrator of the compliance system of the present invention.

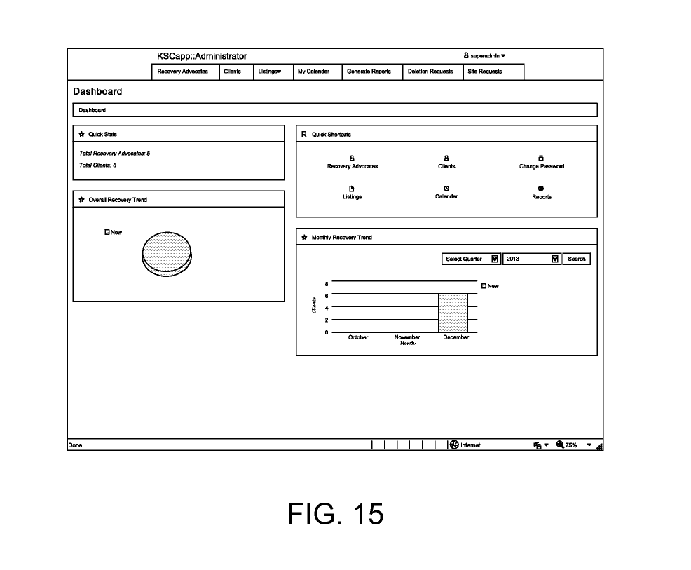

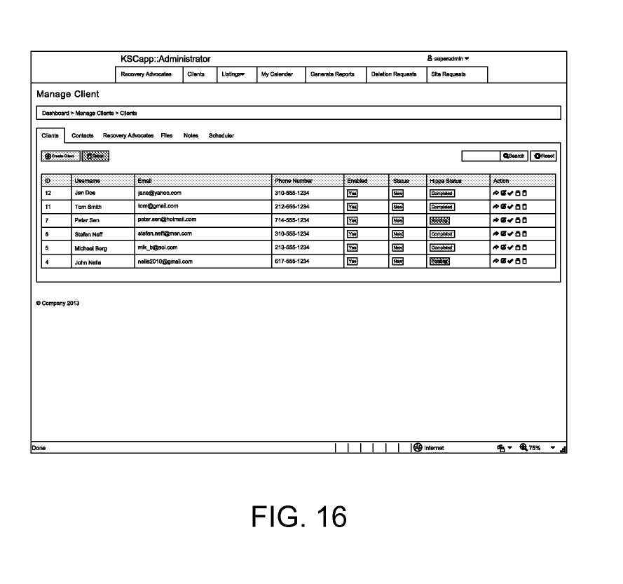

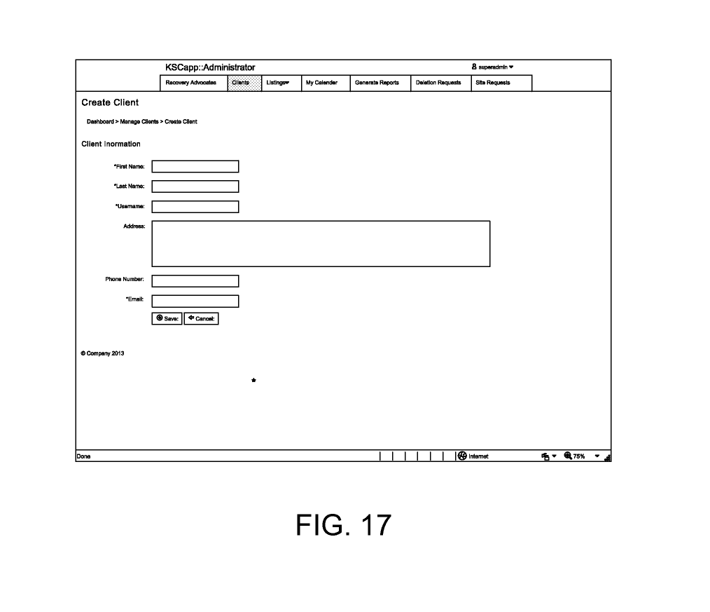

As shown in FIG. 14, a ‘LOG IN’ screen, as is known in the art, is displayed on the workstation screen for the administrator to enter a ‘user name’ and “password’ previously assigned to the administrator. An administrator may grant access permissions (‘user name’ and ‘password’) to other administrators and to advocates for use of the compliance system website multiple workstations (FIG. 2). After the administrator has entered a valid ‘user name’ and “password’, the website provides a ‘dashboard’ (graphical user interface-GUI) for the administrator to navigate through the website's functionality (see FIG. 15). One function available to the administrator is to ‘Manage Clients’ (previously referred herein as “users” of the compliance module of the mobile computing device). As shown in FIG. 16, the administrator may select a particular client ‘hover and click’ via a mouse or ‘scroll + enter’ via a keyboard) so as to view and/or modify client particulars, such as the contacts and calendared appointments that have been entered by a client using the mobile user interface. Alternatively, the administrator may enter the particulars for a new client from a “Create Client” screen programmed into the website functionality (FIG. 17).

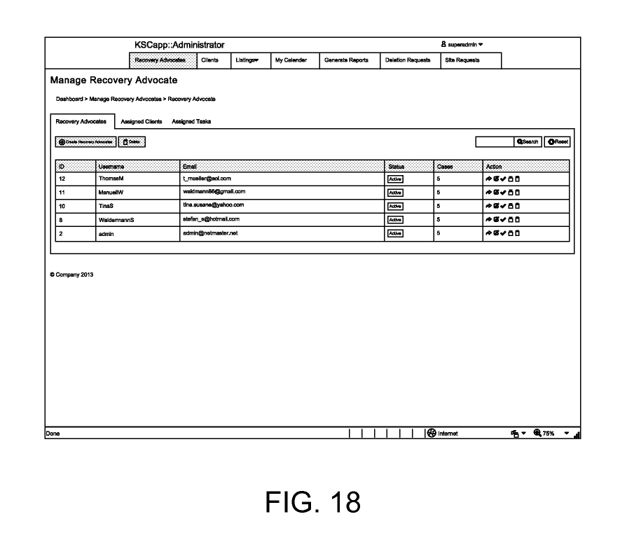

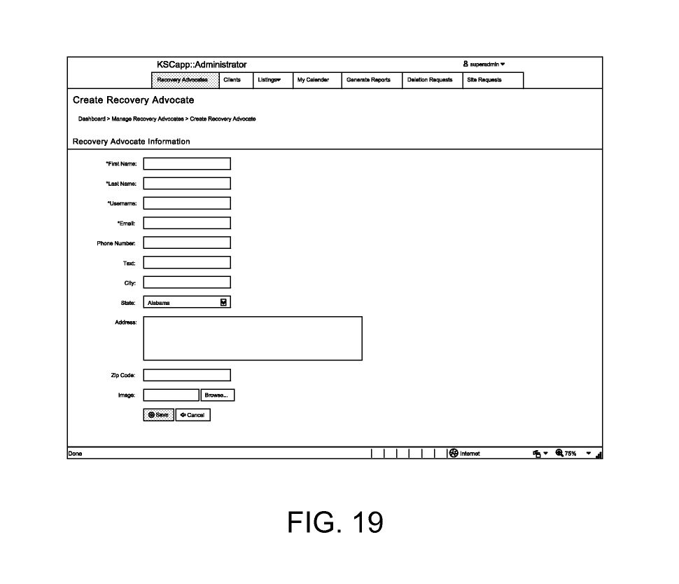

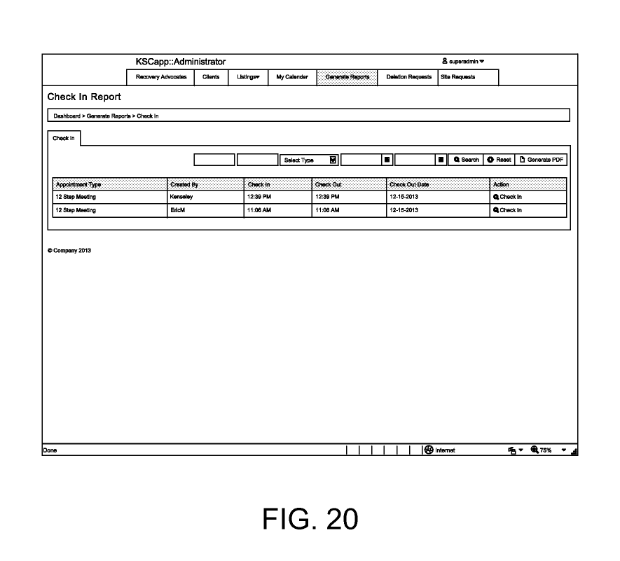

As shown in FIG. 18, another function available to the administrator is to ‘Manage Recovery Advocates’, wherein the administrator may select a particular advocate so as to view and/or modify the advocate's particulars, such as the advocate's contact information, assigned clients and assigned tasks. Further, the administrator may enter the particulars for an administrator from a “Create Recovery Advocate” screen (FIG. 19). In addition, dashboard and website functionality provide the administrator the ability to generate (print, save in memory) reports from the data uploaded from the users, advocates and other data stored in the memory of the mobile computing devices, the workstations and/or the computer servers in accordance with the system of the present invention. For example, the administrator may generate a report detailing a patient's (client, user) attendance records (check in report) at scheduled appointments (FIG. 20). From this screen and the fields associated with the appointments, the administrator and advocates can verify attendance at the scheduled appointments, including comparison of a ‘location stamp’ against the actual address of the appointment location. Further, a “My Calendar’ tab is included for the administrators and advocates for scheduling their own appointments and tasks. The advocate “My Calendar” functionality also provides a backup aspect of the compliance system. For example, when an advocate is unavailable to follow-up on her/his own appointments and tasks listed in a “My Calendar” daily log, an administrator or another advocate can attend the appointments and complete the tasks of the unavailable advocate.

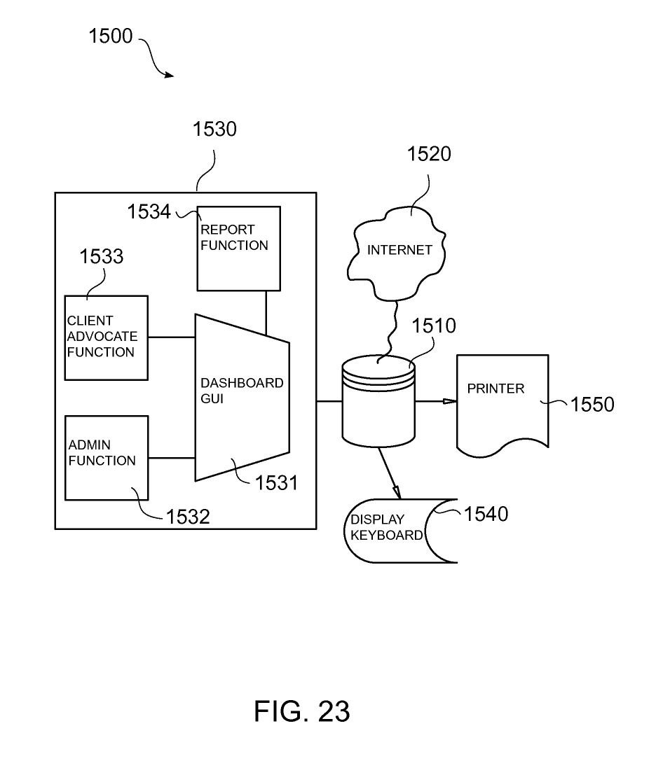

The server, mobile computing device and workstation computer functionality is shown in FIGS. 21-23. The server functionality 1300 includes one or more computers 1310 that interface with the Internet 1320 (FIG. 21). The server hardware includes a central processing unit and one or more types of nontransitory memory that operate and store the programming and data for interfacing with the mobile computing device (FIG. 22) and the computer workstation (FIG. 23). The server functionality includes data storage 1330 and compliance module download 1340, for example, from on-line store to mobile computing device. The computer server may also be configured (programmed) with an interface sub-system 1350 to the mobile computing devices for receiving and sending user data. In addition, the server may be configured to interface 1360 with each computer workstation for receiving and sending data to and from the administrators and recovery advocates.

An embodiment of the mobile computing device and compliance module apparatus 1400 of the present invention is shown in FIG. 22. By way of example, the compliance module 1410 includes functionality (programming, app) for ‘log in’ 1411, a. ‘home screen’ 1412, a sobriety module 1413 (date entry and counter), and an interface 1414 for the user to view and accept a HIPAA (Health Insurance Portability and Accountability Act) release form. Further compliance modules are configured for contact entry and maintenance 1415 (see FIGS. 6 and 7), for appointments and ‘check in’ 1416 (see FIGS. 9, 10 and 11), for a calendar and notifications 1417 (see FIG. 8), for requesting, displaying and storing test data 1418 (see FIG. 13) and for available services 1419 (see FIG. 12).

Referring again to FIG. 22, the hardware of the mobile computing device (see FIGS. 1, 2 and 3A) is generally depicted, but not intended to be limiting, as containing a central processor (CPU) 1420 connected to a power supply 1423 and memory devices 1425. The CUP is operably configured with an operating system 1421 (for example, iOS, Windows Mobile and Android) and a display module 1422 with optional touch screen capability 1424. The evolution of mobile computing devices is fast and furious. A walk though any telecommunications store provides an array of mobile devices such as smartphones, laptops and so-called tablet computers that are configured with radio capability 1426, Wi-Fi connectivity 1427 and similar interfaces to the Internet 1430 and other electronic communication systems. Accordingly, the compliance module and functionality is not intended to be limited by a particular hardware configuration. The computer hardware, however, is necessary for operation of the various modules, storage of resident data and interface with the user and with the administrator-advocate workstations.

A typical workstation 1500 is shown in FIG. 23, which is by way of example and not intended be limiting. As heretofore described, the workstation includes a computer 1510 (for example, but not limited to, processor, power supply, memory) operably connected to the Internet 1520. User interaction is typically though separate or integrated display and keyboard hardware 1540. A printer 1150 may be connected to the workstation processor for generating reports, and similar functions. As is known today, a web browser 1530 includes the basic functionality to provide user display and interaction using a front-end dashboard (GUI) 1531 that provides access and interaction with the administrator function 1532, the client and advocate functions 1533 and a reporting function 1534.

Referring now to FIG. 24, the process 1600 for entering the particulars (data, information) related to a contact, specifically a doctor, begins with the step of downloading 1602 the compliance module to the mobile computing device, if the module is not resident on the device. The user is then prompted 1603 to enter her/his tog in details (identification and password information—see FIG. 4), which, if correct, causes the compliance module to display 1610 the ‘Home” screen (FIG. 5). If the user has not previously ‘agreed’, then a HIPAA form is displayed to the user. The HIPAA release form provides permission from the user of the compliance module for the administrators and advocates to use the contact list and other information entered by the user in the event of an emergency of or user relapse from the prescribed treatment plan and sobriety protocols. From the “Home” screen, the compliance module provides the user an opportunity to update 1604 (add, change) the user's ‘sobriety’ date. If the user requests to update 1605, then the module provides display screens and functionality to enter 1606 the new sobriety date, which is stored 1607 on the mobile computing device and a counter is triggered. At almost any time during the contact entry process and from most mobile user interface screens (see FIGS. 6, 8, 9, 12 and 13), the user can navigate the mobile user interface to display 1610 the “Home” screen.

For purposes of simplifying the diagram in FIG. 24, the user may select 1632 from the entries on the “Home” screen the button. 410 for adding a contact (FIG. 5), which moves the user display to the contact selection screen (FIG. 6). The user selects a contact type 1612, for example, selecting a doctor 1614. If the user elects not to complete the data entry process 1616 (button 670 in FIG. 7), then the compliance module reverts 1615 to the display screen for the user to select 1612 a different contact type or navigate back to the “Home” screen 1610. If the user elects to enter doctor's contact information (populating the fields in FIG. 7), then the user may push the add button 680, as shown in FIG. 7. At that time, the doctor's contact information is stored 1620 in the mobile computing device memory and/or the computer server memory. If the user provides permission (by sliding button 660, as shown in FIG. 7), then the administrator-advocate workstation may upload the contact information for the doctor so as to associate the data with the user (client), as shown in FIG. 16.

One embodiment of the process 1700 for adding and confirming an appointment is shown in FIG. 25. The Appointment List screen 1710 (FIG. 9) is accessible when the “Home” screen is displayed 1710, which is accessible from most portions (screens) of the process demonstrated in FIG. 25. If the user elects 1720 to enter 1730 the appointment details (populating the fields in FIG. 10), the compliance module stores 1735 the data in the mobile computing device memory and/or the computer server memory. The compliance module may provide reminders, such as alerts and banners to inform the user of the scheduled appointment, which may be accessible from the “Calendar” page (see FIG. 8) and the “Appointments and Notes” display 1740 (see FIG. 9). Id the user elects not to add an appointment the mobile user interface remains 1725 at the “Appointments and Notes” display.

For simplicity of FIG. 25, the ‘check in’ process (see FIG. 11 and associated text herein) begins by viewing 1740 the appointment, for example, from the “Home” screen display 1710. Upon viewing the appointment, the user is prompted 1750 by the compliance module to confirm attendance (check in) at the appointment. If the user does not elect to ‘check in’ to the appointment, then the compliance module returns 1755 to the ‘View Appointment’ screen. If the user elects to ‘check in’ then the user is required to obtain 1760 an authorized signature using 1765 the screens programmed in the compliance module (see FIG. 11, button 1060 and associated text herein). The compliance method in the mobile computing device may also forward a ‘location stamp’ generated by GPS (global position system) or other functionality configured into the mobile computer platform. The user may enter notes 1770 regarding the appointment and/or return to the “Home” screen 1710.

As shown in FIG. 11 and with further reference to FIG. 25 the user may push button 1095 after the ‘View Appointment’ step 1740 to request certification 1780 of attendance at the appointment (check out). Upon a check out request 1782, the compliance module verifies 1784 that an authorized signature was obtained. If no signature was obtained, then the compliance module reverts 1785 to the screen 1760 in the mobile user interface where the signature module 1765 can be accessed. If a signature has been obtained 1786, then the verification data is transmitted 1790 to the administrator server and/or workstations, and the compliance module reverts to the ‘View Appointment’ step 1740, which displays the verified appointment attendance data on the mobile user interface screen.

While particular forms of the invention have been illustrated and described with regard to mobile computing devices, computer workstations and computer servers, it will be apparent to those skilled in the art that various modifications to the software and hardware can be made without departing from the scope of the invention. More specifically, one of ordinary skill in the art will understand that the present invention is not limited to any particular method of operating the disclosed compliance module. Modifications and improvements to the compliance module functionality may be made without departing from the scope of the invention. Accordingly, it is not intended that the invention be limited beyond the intended scope of the invention, for example, but not limited to, the appended claims.

We claim:

1. A nontransitory computer readable medium configured to store instructions, the instructions when executed by a processor cause the processor to perform steps comprising:
detecting a first user request that is made using a compliance module resident on a computing device having a nontransitory computer readable medium and a processor; and
responding to the first user request, including:
(i) retrieving at least one appointment data from at least one memory resource of the computing device,
(ii) presenting the least one appointment data on a display of the computing device,
(iii) enabling the user to select a first appointment data from the at least one appointment data, and
(iv) initiating a verification module resident on the computing device and configured for verification of the appointment in response to the user selecting the first appointment data.

2. The nontransitory computer readable medium of claim 1, wherein the instructions cause the verification module to accept a signature from the display of the computing device.

3. The nontransitory computer readable medium of claim 2, wherein the instructions cause the verification module to store the written signature into the at least one memory resource.

4. The nontransitory computer readable medium of claim 3, wherein the instructions further cause the verification module is to include geographic location information of the computing device.

5. The nontransitory computer readable medium of claim 4, wherein the instructions cause the verification module to store the geographic location information into the at least one memory resource.

6. The nontransitory computer readable medium of claim 1, wherein the compliance module further comprises instructions when executed by a processor causes the processor to perform the steps of:
(v) enabling the user to enter a second appointment data into the at least one memory resource, wherein the second appointment data includes medication information and a schedule for the medication information;
(vi) storing the second appointment data into the at least one memory resource;
(vii) presenting the medication information on the display of the computing device according to the medication schedule; and
(viii) enabling the user to select the second appointment data and to verify compliance with the medication schedule.

7. A computer-implemented method on a computing device configured for plan compliance, comprising:
activating a compliance module resident on a computing device having a nontransitory computer readable medium and a processor;
detecting a first user request that is made using the compliance module;
retrieving at least one appointment data from at least one memory resource of the computing device;
presenting at least one appointment data on a display of the computing device;
enabling the user to select a first appointment from the at least one appointment data, and
initiating a verification module resident on the computing device and configured for verification of the first appointment in response to the user selecting the first appointment.

8. The computer-implemented method of claim 7, wherein the verification module is configured to accept a written signature and to store the written signature into the at least one memory resource.

9. The computer-implemented method of claim 8, wherein the verification module is further configured to determine the geographic location information of the computing device and to store the geographic location information into the at least one memory resource.

10. The computer-implemented method of claim 8, further comprising transmitting the written signature to a computer workstation remote from the computing device.

11. The computer-implemented method of claim 9, further comprising transmitting the written signature and the geographic location information to a computer workstation remote from the computing device.

12. The computer-implemented method of claim 7, wherein activating the compliance module further comprises:
enabling the user to enter a second appointment data into the at least one memory resource, wherein the second appointment data includes medication information and a schedule for the medication information;
storing the second appointment data into the at least one memory resource; and
presenting the medication information on the display of the computing device according to the medication schedule.

13. The computer-implemented method of claim 12, further comprising enabling the user to select the second appointment data and to enter compliance verification for the medication schedule.

14. The computer-implemented method of claim 12, further comprising transmitting the second appointment data to a computer workstation remote from the computing device.

15. The computer-implemented method of claim 13, further comprising transmitting the second appointment data and the compliance verification to a computer workstation remote from the computing device.

16. A mobile computing apparatus for providing plan compliance information and user interaction comprising:
a processor;
a display screen;
at least one memory resource; and
a storage medium to store instructions of a compliance module that when executed by the processor, cause the processor to:
(i) activate display module that operates to provide data on the display screen,
(ii) retrieve at least one appointment data from the at least one memory resource,
(iii) present at least one appointment data the on the display screen, and
(iv) enable a user to select a first appointment data.

17. The mobile computing apparatus of claim 16, wherein the compliance module is further configured to initiate a verification module in response to the user selecting the first appointment data, and wherein the verification module is configured to obtain a written signature, to store the written signature in the at least one memory resource and to trans it the written signature to a computer workstation remote from the computing device.

18. The mobile computing apparatus of claim 17, herein the verification module is further configured to determine geographic location information of the mobile computing apparatus, and wherein the mobile computing apparatus is configured to transmit the geographic location information to a computer workstation remote from the mobile computing apparatus.

19. The mobile computing apparatus of claim 16, wherein the compliance module includes further instructions that when executed by the processor, cause the processor to:
enable the user to enter a second appointment data into the at least one memory resource, wherein the second appointment data includes medication information and a schedule for the medication information;
store the second appointment data into the at least one memory resource; and
present the medication information on the display screen according to the medication schedule.

20. The mobile computing apparatus of claim 19, wherein the compliance module is further configured to enable the user to select the second appointment data and to enter compliance verification for the medication schedule, and wherein the mobile computing apparatus is configured to transmit the second appointment data the compliance verification to a computer workstation remote from the mobile computing apparatus.
